(19) United States
(12) Patent Application Publication
(10) Pub. No.: US 2021/0331846 A1
(43) Pub. Date: Oct. 28, 2021

(54) PACKAGE BODY HAVING LAMINATED FILM INCLUDING RECYCLED PLASTIC LAYER

(71) Applicant: TCI CO., LTD., Taipei (TW)

(72) Inventors: YUNG-HSIANG LIN, Taipei (TW); I-JU WU, Taipei (TW)

(21) Appl. No.: 17/241,088

(22) Filed: Apr. 27, 2021

(30) Foreign Application Priority Data
Apr. 27, 2020 (TW) 109205027

(51) Int. Cl. B65D 65/40; B32B 15/09; B32B 7/12; B32B 27/08; B32B 15/20; B32B 27/36

(52) U.S. Cl. CPC B65D 65/40; B32B 15/09; B32B 7/12; B32B 27/08; B32B 15/20; B32B 27/36; B32B 2307/4023; B32B 2250/05; B32B 2439/06; B32B 2255/205; B32B 2255/10; B32B 2307/7244; B32B 2307/7246; B32B 2250/03

(57) ABSTRACT

Provided is a package body having a laminated film. The laminated film includes a recycled polyethylene terephthalate (PET) layer; a first thermoplastic resin layer; a barrier layer disposed between the recycled PET layer and the first thermoplastic resin layer, the barrier layer being a metal foil layer or a metal-coated resin layer; and a second thermoplastic resin layer located between the recycled PET layer and the barrier layer, and being in direct contact with the barrier layer.

### CROSS-REFERENCE TO RELATED APPLICATION

This non-provisional application claims priority under 35 U.S.C. § 119(a) to Patent Application No. 109205027 filed in Taiwan, R.O.C. on Apr. 27, 2020, the entire contents of which are hereby incorporated by reference.

### BACKGROUND

### Technical Field

The disclosure relates to a package body having a laminated film, and in particular, to a laminated film including a recycled plastic layer.

### Related Art

In many fields, there is a need to package an article or material for preservation and transportation. Especially in the fields of medical treatment, health care, or cosmetic products, the article or material in these fields may contain ingredients that are prone to deterioration. To prevent the deterioration of the internal ingredients, further property requirements are required for their external packages, such as oxygen barrier properties or water vapor barrier properties. To achieve the foregoing requirements, the external packages are usually required to use a large amount of plastic, which has a great effect and impact on the environment.

### SUMMARY

In view of the foregoing, to reduce the effect and impact on the environment caused by the package body manufacturing, the disclosure provides a package body including a laminated film. The laminated film includes a recycled polyethylene terephthalate (PET) layer, a first thermoplastic resin layer, a barrier layer disposed between the recycled PET layer and the first thermoplastic resin layer, and a second thermoplastic resin layer located between the recycled PET layer and the barrier layer. The barrier layer is a metal foil layer or a metal-coated resin layer. The second thermoplastic resin layer is in direct contact with the recycled PET layer.

According to some embodiments, the first thermoplastic resin layer is selected from at least one of the group consisting of a polyethylene (PE) film, a low density polyethylene (LDPE) film, a linear low density polyethylene (LLDPE) film, a medium density polyethylene (MDPE) film, a high density polyethylene (HDPE) film, an acrylic copolymer resin film, a polypropylene (PP) film, a cast polypropylene (CPP) film, and an oriented polypropylene (OPP) film.

According to some embodiments, the metal foil layer is an aluminum foil layer or a copper foil layer.

According to some embodiments, the metal-coated resin layer is an aluminum-coated resin layer.

According to some embodiments, the thickness of the recycled PET layer is less than the thickness of the first thermoplastic resin layer.

According to some embodiments, the aluminum-coated resin layer is an aluminum-coated cast polypropylene film, an aluminum-coated oriented polypropylene film, or an aluminum-coated polyethylene terephthalate film.

According to some embodiments, the thickness of the recycled PET layer is 12 μm-15 μm.

According to some embodiments, the thickness of the first thermoplastic resin layer is 30 μm-50 μm.

According to some embodiments, the total thickness of the laminated film is 35 μm-150 μm.

According to some embodiments, the laminated film further includes an adhesive layer located between the recycled PET layer and the barrier layer.

According to some embodiments, the laminated film further includes another adhesive layer located between the barrier layer and the first thermoplastic resin layer.

According to some embodiments, the barrier layer in the laminated film is the metal foil layer, and the laminated film further includes a third thermoplastic resin layer located between the barrier layer and the first thermoplastic resin layer. The third thermoplastic resin layer is in direct contact with the barrier layer.

According to some embodiments, an ink layer is provided on a side of the recycled PET layer close to the first thermoplastic resin layer.

According to some embodiments, the ink layer is in direct contact with the recycled PET layer.

By using the package body of any of the embodiments, the amount of new plastics used for manufacturing the package bodies can be reduced, which may achieve resource recycling and reutilization, and thus reduces/eliminates adverse effects caused by producing the new plastics. In addition, when an additional thermoplastic resin layer is provided on at least one of both sides of a metal layer in the laminated film, the mechanical strength, gas barrier properties, and water barrier properties of the package body can be further improved. Therefore, a good balance between preservation function and consumption amount of new plastics for the package body can be obtained.

### BRIEF DESCRIPTION OF THE DRAWINGS

FIG. 1 is a schematic cross-sectional view of a laminated film structure according to some embodiments of the disclosure;

FIG. 2 is a schematic cross-sectional view of a laminated film structure according to some embodiments of the disclosure;

FIG. 3 is a schematic cross-sectional view of a laminated film structure according to other embodiments of the disclosure;

FIG. 4 is a schematic cross-sectional view of a laminated film structure according to other embodiments of the disclosure; and

FIG. 5 is a schematic perspective view of a package body according to some embodiments of the disclosure.

### DETAILED DESCRIPTION

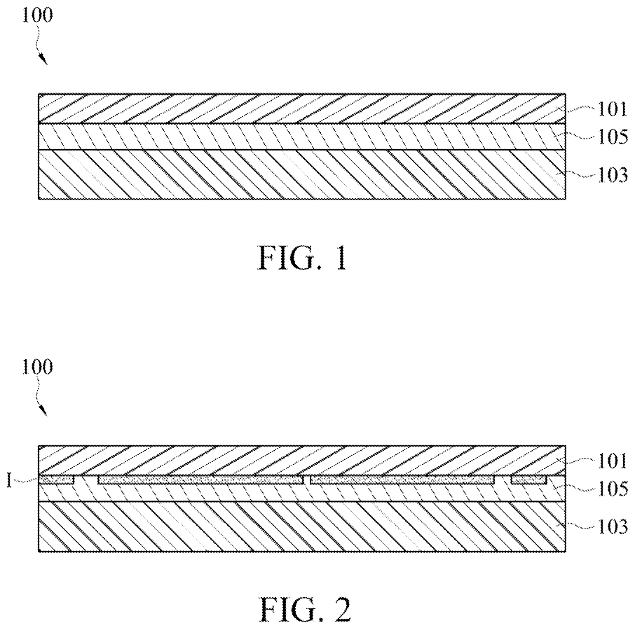

Please refer to FIG. 1. FIG. 1 is a schematic cross-sectional view of a laminated film 100 structure according to some embodiments of the disclosure. In some embodiments, the laminated film 100 may be used to manufacture a package body for various uses, such as a medical package body like an infusion bag, a care product package body like a facial mask package bag, a food package body, or an industrial package body.

As shown in FIG. 1, according to some embodiments, the laminated film 100 may include a recycled plastic layer 101, a thermoplastic resin layer (referred to as a first thermoplastic resin layer 103 below), and a barrier layer 105. The barrier layer 105 is disposed between the recycled plastic layer 101 and the first thermoplastic resin layer 103. The barrier layer 105 may be a metal foil layer or a metal-coated resin layer. In some embodiments, one side of the barrier layer 105 is in direct contact with the recycled plastic layer 101, and the opposite side of the barrier layer 105 is in direct contact with the first thermoplastic resin layer 103.

The recycled plastic layer 101 is made of recycled plastic. In some embodiments, the recycled plastic layer 101 may be a recycled polyethylene terephthalate (PET) layer. In some embodiments, the recycled polyethylene terephthalate (PET) layer may be a marine recycled polyethylene terephthalate (PET) layer.

In some embodiments, the recycled plastic is obtained by crushing human plastic waste gathered from ocean into fragments or scraps. The fragments or scraps are then washed and dried. In some cases, a suitable modification agent may be added therein, and then the fragments or scraps are thermally molded to form plastic pellets, which can be further manufactured into a recycled PET plastic layer (since it is made from the plastic waste gathered from ocean, this recycled PET plastic layer may be referred to as the marine recycled PET plastic layer). The modification agent may be selected from maleic anhydride grafted polymers, thermoplastic polyester elastomers (TPEE), and a combination thereof. The modification agent can be used for improving the compatibility between the recycled plastic materials, or making the plastic layer made from the fragments or scraps containing the modification agent softer to increase the toughness.

In some embodiments, the recycled PET used in the recycled PET layer is recycled from PET bottles, which makes the composition of the recycled PET be different from that of a new PET material. When PET bottles are manufactured, a plasticizer, for example, dimethyl isophthalate, is added into a new PET material. After steps of heating and molding, at least a portion of dimethyl isophthalate remains in the material of the PET bottles by a form of isophthalate copolymer. During the recycling process of the recycled PET, the isophthalate copolymer cannot be completely removed, so that the recycled PET layer made of this recycled material contains the isophthalate copolymer (compared to a new PET material). In some embodiments, the recycled PET layer contains 0.1-2.5 wt % of isophthalate copolymer.

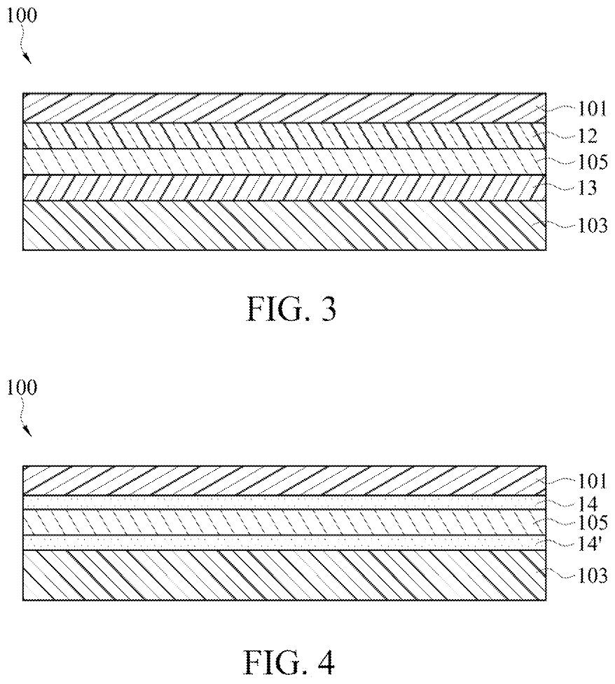

In some embodiments, because the PET material used in the recycled PET layer may have the molecular chain broken due to high temperature during the recycling process, the viscosity of the recycled PET (measured by using a capillary viscosity test method) is about 0.55-0.58 dL/g, which is slightly less than the viscosity (about 0.6-0.7 dL/g) of the PET used in the plastic layer produced from the new material. Thus, the recycled PET may have a low viscosity coefficient, poor flow stability, and/or poor transparency. However, by using current physical or chemical methods, recycled plastics can overcome the foregoing shortcomings, have acceptable appearance, and still have properties such as broad range of operating temperature, good water vapor and gas barrier property, and high mechanical strength, so that the package made from such recycled plastics still can effectively protect objects therein. On the other hand, in some embodiments, additional chemical components, for example, a thickener, may not be required to be added into the recycled PET, but a thermoplastic resin layer (for example, a second thermoplastic resin layer 12 shown in FIG. 3, which may be in direct contact with the recycled plastic layer 101) is disposed between the recycled plastic layer 101 and the barrier layer 105 in the laminated film 100. Accordingly, although the recycled PET layer manufactured without additional chemical components, the entire laminated film 100 may still have good stability and mechanical strength.

Therefore, the laminated film 100 according to any of embodiments has good mechanical strength and other properties, and allows further reduction of the consumption amount of new plastics. Accordingly, resource recycling and reutilization can be achieved through the laminated film 100, and thereby reducing/eliminating adverse effects caused by the production of new plastics.

According to some embodiments, the thickness of the recycled plastic layer 101 may be 10 μm-40 μm, for example, 12 μm-15 μm. By having the thickness of the recycled plastic layer 101 in such a range, it is ensured that the package body made from the laminated film 100 can have sufficient strength and higher formability since the stress generated during bulging process can be reduced. In addition, in some embodiments, the thickness of the recycled plastic layer 101 may be less than the thickness of the first thermoplastic resin layer 103.

In some embodiments, the melting point of the recycled plastic layer 101 is higher than the melting point of the first thermoplastic resin layer 103. Thus, the laminated film 100 can have good structural stability during heat sealing for package/bag manufacturing.

In some embodiments, as shown in FIG. 2, an ink layer 1 may be disposed on one side of the recycled plastic layer 101 close to the first thermoplastic resin layer 103. In some embodiments, the ink layer 1 may be in direct contact with the recycled plastic layer 101. In some embodiments, when the laminated film 100 is viewed from an outer side of the laminated film 100 (for example, a side of the recycled plastic layer 101 away from the barrier layer 105), and the recycled plastic layer 101 has at least partial light transmittance, the ink layer 1 may impart color or text to the laminated film 100 for display. Because the ink layer 1 is disposed between layers, the ink layer 1 is not easy to peel off and/or fall off from the laminated film 100.

In some embodiments, the first thermoplastic resin layer 103 of the laminated film 100 may be suitable for heat sealing. In some embodiments, the first thermoplastic resin layer 103 is a thin film without adhesion at room temperature (for example, 20-25° C. or less). The two laminated films 100 can be adhered to each other by first overlapping the two laminated films 100 with their first thermoplastic resin layers 103 contacting with each other, applying heat and pressure on them, and then making it cool. The two laminated films 100 thus can be melted and bond to each other, so that adhesion between them can be achieved.

In some embodiments, the material of the first thermoplastic resin layer 103 may include polyethylene (PE), polypropylene (PP), ethylene-vinyl acetate copolymer (EVA), acrylic copolymer resin, polyester, polyamide, or a combination thereof. Specifically, the PE may be, for example, low density polyethylene (LDPE), linear low density polyethylene (LLDPE), medium density polyethylene (MDPE), high density polyethylene (HDPE), or any combination thereof. The PP may be a cast polypropylene (CPP), an oriented polypropylene (OPP), or any combination thereof. The polyester may be for example polyethylene terephthalate, polybutylene terephthalate, or polyethylene naphthalate. The polyamide may be nylon-6, nylon-66, polymetaxylene adipamide, or any combination thereof.

In some embodiments, the material of the first thermoplastic resin layer 103 may be a thermoplastic resin material with relatively high temperature resistance, for example, polypropylene. The package body manufactured by the laminated film 100 having such the first thermoplastic resin layer 103 can be subjected to a high-temperature (for example, up to 120° C.) sterilization process, and the structure of the package body can still be maintained intact and not damaged at high temperature, so that the preservation ability of the package body can be further improved.

In some embodiments, the first thermoplastic resin layer 103 may be a non-stretched film or a stretched film. For example, resin may be melted and extruded into a sheet by an extrusion film forming method. Then, the sheet is stretched in both axial directions simultaneously or successively, so as to form the first thermoplastic resin layer 103 in the form of the stretched film.

In some embodiments, the first thermoplastic resin layer 103 may be adhered to the barrier layer 105, that is, in direct contact with the barrier layer 105. In an exemplary embodiment, one or both surfaces of the first thermoplastic resin layer 103 may undergo surface-activated treatment (such as corona treatment, flame treatment, plasma treatment, and primer coat treatment) prior to being bonded to the barrier layer 105 for improving the adhesion between the first thermoplastic resin layer 103 and the barrier layer 105.

According to some embodiments, the thickness of the first thermoplastic resin layer 103 may be 20 μm-70 μm, for example, 30 μm-50 μm. By having the thickness of first thermoplastic resin layer 103 in such a range, it is ensured that the package body prepared from the laminated film 100 has sufficient strength and the required water and gas barrier properties. It may also improve the formability of the laminated film 100 since the stress generated during bulging process can be reduced. Furthermore, the package body made from the laminated film 100 can contact the object in the package body stably without generating further chemical reaction, thereby effectively preserving the packaged object.

In some embodiments, the barrier layer 105 can help prevent oxygen or moisture from penetrating into the package body. The barrier layer 105 also has a light-shading property, and thus further provides the package body made from the laminated film 100 with better barrier function to insulate an external environment.

In some embodiments, besides the first thermoplastic resin layer 103, a thermoplastic resin layer may be disposed on both sides or at least one side of the metal layer 105. For example, referring to FIG. 3, a second thermoplastic resin layer 12 and a third thermoplastic resin layer 13 are respectively provided on opposite sides of the metal layer 105. By such arrangement, the laminated film 100 can have better strength and gas/water barrier properties. In some embodiments, the second thermoplastic resin layer 12 is disposed between the recycled plastic layer 101 and the barrier layer 105, and is in direct contact with one surface of the barrier layer 105. The third thermoplastic resin layer 13 is disposed between the barrier layer 105 and the first thermoplastic resin layer 103, and is in direct contact with the other surface of the barrier layer 105. In some embodiments, the third thermoplastic resin layer 13 may be in direct contact with the first thermoplastic resin layer 103, and there is still a clear interface between the third thermoplastic resin layer 13 and the first thermoplastic resin layer 103. For example, materials of the third thermoplastic resin layer 13 and the first thermoplastic resin layer 103 may be different, or there may be an adhesive layer between the two layers.

In some embodiments, the material of the second thermoplastic resin layer 12 or the material of the third thermoplastic resin layer 13 may include PE, PP, EVA, acrylic copolymer resin, polyester, polyamide, or a combination thereof. Specifically, the PE may be LDPE, LLDPE, MDPE, HDPE, or any combination thereof. The PP may be CPP, OPP, or any combination thereof. The polyester may be, for example, polyethylene terephthalate, polybutylene terephthalate, or polyethylene naphthalate. The polyamide may be nylon-6, nylon-66, polymetaxylene adipamide, or any combination thereof. It should be understood that the first thermoplastic resin layer 103, the second thermoplastic resin layer 12, and the third thermoplastic resin layer 13 may be made of the same material or different materials.

In some embodiments, the second thermoplastic resin layer 12 or the third thermoplastic resin layer 13 may be a non-stretched film or a stretched film. For example, resin may be melted and extruded into a sheet by an extrusion film forming method. Then, the sheet is stretched in both axial directions simultaneously or successively, so as to form the second thermoplastic resin layer 12 or the third thermoplastic resin layer 13 in the form of the stretched film.

In some embodiments, the second thermoplastic resin layer 12 or the third thermoplastic resin layer 13 may be formed by spray-film method. In this case, the second thermoplastic resin layer 12 or the third thermoplastic resin layer 13 may be used as an adhesion layer between upper and lower layers in direct contact with it. For example, the second thermoplastic resin layer 12 may be formed on the recycled plastic layer 101 by spray-film method, and when the second thermoplastic resin layer 12 is not completely cooled and is sticky, the barrier layer 105 is adhered to the second thermoplastic resin layer 12. In some embodiments, the melting point of the recycled plastic layer 101 may be higher than that of the second thermoplastic resin layer 12 or the third thermoplastic resin layer 13.

According to some embodiments, the thickness of the second thermoplastic resin layer 12 or the third thermoplastic resin layer 13 may be 2 μm-20 μm, for example, 10 μm-15 μm. By having the thickness in such a range, it is ensured that the package body prepared from the laminated film 100 has sufficient strength and the required water and gas barrier properties. It may also improve the formability of the laminated film 100 since the stress generated during bulging process can be reduced.

In some embodiments, the barrier layer 105 may be a metal foil layer, so that the laminated film 100 has rigidity, a bright visual appearance, and excellent light shading effect, water barrier, and fragrance retaining properties. Accordingly, the object in the package body prepared from the laminated film 100 can be effectively protected.

The metal foil layer may be, for example, an aluminum foil layer or a copper foil layer, usually the aluminum foil layer. In some embodiments, the thickness of the barrier layer 105 may be 4 μm-120 μm, for example, 18 μm-100 μm. For the thickness of the metal foil layer of 18 μm or more, the pinholes are avoided during rolling when manufacturing the metal foil layer. When the thickness of the metal foil layer is 25 μm or more, the laminated film 100 can have excellent gas and water barrier properties. When the thickness of the metal foil layer is 100 μm or less, the stress generated during bulging or deep drawing can be reduced, so as to improve the formability of the package body prepared from the laminated film 100.

In some embodiments, the barrier layer 105 may also be a metal-coated resin layer. For example, a very thin metal layer is formed by vapor deposition on a plastic film to form the metal-coated resin layer. The metal-coated resin layer may be an aluminum-coated plastic film. For example, the metal-coated resin layer may be, for example, an aluminum-coated cast polypropylene film (such as vacuum-matellized cast polypropylene film (VMCPP)), an aluminum-coated oriented polypropylene film (such as vacuum-matellized oriented polypropylene film (VMOPP)), or an aluminum-coated polyethylene terephthalate film (such as vacuum-metallized polyester film (VMPET)).

The metal-coated resin layer therefore has both the properties of a plastic film and the properties and appearance of a metal film. In other words, the metal-coated resin layer has a better gas barrier property, light shading property, and anti-ultraviolet effect than those of a common plastic film. Compared with a common metal foil layer, the metal-coated resin layer has lower heat penetration and thermal conductivity, better thermal insulation, and better puncture resistance.

In some embodiments, referring to FIG. 4, an adhesive layer may be disposed between two layers to be bonded to have better adhesion and fixing effects between the layers. For example, as shown in FIG. 4, an adhesive layer 14 may be formed between the recycled plastic layer 101 and the barrier layer 105, and an adhesive layer 14′ may be formed between the barrier layer 105 and the first thermoplastic resin layer 103.

In some embodiments, the adhesive layers 14 and 14′ may be formed respectively from a layer of adhesive after being dried. For example, a two-component reactive adhesive may be coated on surface(s) of any one or two layers to be bonded by the adhesive layer, and after the two layers are bonded, the adhesive between the two layers is dried to form the adhesive layer. In some embodiments, the two-component reactive adhesive may include a first component and a second component (a hardener). The first component may be composed of one or more of polyols selected from the group consisting of polyurethane-based polyols, polyester-based polyols, and polyether-based polyols. The second component may be composed of isocyanate. In some exemplary embodiments, the adhesive may be acrylate resin, methyl methacrylate resin, or polyethylenimine resin. The material of the adhesive layer 14 and the material of the adhesive layer 14′ may be the same or different, depending on the required properties.

In some embodiments, the adhesive may be any one of a solvent type or a solvent-free type. In the case of the solvent type, the solvent may also be used as a medium for the reaction between the first component and the second component. The usable solvent may be esters, such as ethyl acetate, butyl acetate, or cellosolve acetate; ketones, such as acetone, methyl ethyl ketone, isobutyl ketone, or cyclohexanone; ethers, such as tetrahydrofuran; aromatic hydrocarbons, such as toluene or xylene; halogenated hydrocarbons, such as methylene chloride or vinyl chloride; dimethyl sulfoxide, dimethyl sulfonamide, or the like. Preferably, the solvent may be ethyl acetate or methyl ethyl ketone.

In some embodiments, a solvent that can dissolve the recycled plastic layer 101 may also be used as an adhesive to form the adhesive layer 14. For example, methyl ethyl ketone may be used to partially dissolve the recycled plastic layer 101 to adhere to the barrier layer 105 to form the adhesive layer 14.

In some embodiments, a method for coating the adhesive may be, but is not limited to, roll coating, contact roll coating, gravure coating, reverse coating, roll brush coating, spray coating, dipping roll coating, bar coating, scrape coating, air blade coating, drench coating, die lip coating, or extrusion coating by a die nozzle coater.

It should be noted that, when an adhesive is used for bonding two layers, the two layers may still be regarded as in direct contact. For example, as shown in FIG. 4, although there is the adhesive layer 14 formed by the adhesive between the recycled plastic layer 101 and the barrier layer 105, it may still be regarded as the recycled plastic layer 101 in direct contact with the barrier layer 105.

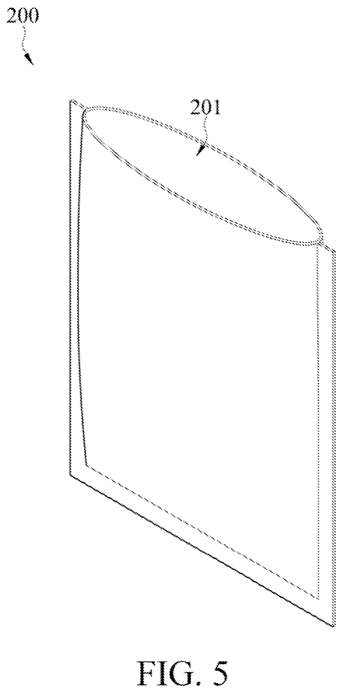

FIG. 5 is a schematic perspective view of a package body 200 according to some embodiments of the disclosure. In some embodiments, referring to FIG. 1 and FIG. 5, after the laminated film 100 is manufactured into the package body 200, the recycled plastic layer 101 may be used as an outer layer of the package body in direct contact with the external environment, and the first thermoplastic resin layer 103 may be used as an inner layer of the package body in direct contact with an object to be packaged. Herein, the laminated film 100 may be manufactured into the package body 200 by using any suitable methods. For example, the package body may be manufactured as follows: the first thermoplastic resin layers 103 of two laminated films 100 are disposed facing each other, and then edges thereof are adhered (for example, by thermal fusing); or the laminated film 100 is folded with the first thermoplastic resin layer 103 as an inner side, and then the edges thereof are adhered (for example, by thermal fusing), and an opening 201 is provided for accessibility of an object to be packaged (that is, edges of the laminated film 100 on one side of the package body 200 are not adhered to each other).

Due to high barrier properties, the laminated film 100 of any of the embodiments is particularly suitable for packaging the products, that is, the objects to be packaged that require gas barrier property and water barrier property. In some embodiments, the object to be packaged may be food, or non-food such as medicines and care products. In some embodiments, the object to be packaged may be in the form of any one of liquid, solid, or powder. In some exemplary embodiments, the package body 200 may be a bag for packaging food, a bag for packaging medicine, an infusion bag, or the like.

The following examples are listed to describe the disclosure in more detail, but the disclosure is not limited to these examples.

### Example 1

With a marine recycled PET layer (12 μm of thickness, commercially available from Nan Ya Plastics Corporation, Taiwan) that meets the Global Recycled Standard (GRS) 4.0 as the recycled plastic layer 101 of the disclosure, methyl ethyl ketone (LOCTITE LIOFOL LA 2702, supplied by Henkel Chemical Technologies (Shanghai) Co., Ltd.) was coated on one side thereof as an adhesive (about 3 μm of thickness), on which an aluminum-coated polyethylene terephthalate (VMPET) film was bonded as the barrier layer 105. After the adhesive was dry, methyl ethyl ketone was also coated as an adhesive (about 3 μm of thickness) on the other side of the VMPET film, on which a PE film (TF-S12, supplied by Chiu Lih Plastic Co. Ltd., Taiwan) was bonded as the first thermoplastic resin layer 103 on the other side, to form a laminated film (referred to as “first laminated film” as follows).

### Example 2

With the marine recycled PET layer in Example 1 as the recycled plastic layer 101 of the present disclosure, a PE layer was formed on one side thereof as the second thermoplastic resin layer 12 by the spray film method, on which an aluminum foil was bonded as the barrier layer 105 (about 6 μm of thickness) before the PE layer (about 15 μm of thickness) was not completely cooled. After the PE layer was cooled, another PE layer was formed as the third thermoplastic resin layer 13 (about 15 μm of thickness) by the spray film method, on a side of the aluminum foil without bonding with other layers. A PET layer (about 12 μm of thickness) was bonded on the PE layer before the PE layer is cooled. After the PE layer was cooled, methyl ethyl ketone was coated as an adhesive (about 3 μm of thickness) on the surface of the PET layer without other layers, and a CPP film was bonded to the adhesive as the first thermoplastic resin layer 103, to form a second laminated film.

Assessment

The first laminated film and the second laminated film prepared in Example 1 and Example 2 were cut into test coupons with a width of 15 cm and a length of 18 cm, respectively as test piece 1 and test piece 2, and measured as follows. The test results were shown in Table 1 below.

(1) Evaluation of Peeling Risk

The test piece 1 and the test piece 2 were measured by using a TENSILON universal testing machine manufactured by ORIENTEC and at environment temperature of 25° C. With the peeling speed set as 300 mm/min, the tensile strength between the thin films peeled by the 180-degree peeling method and the T-type peeling method as the adhesive strength. Those with a tensile strength of 2.5 kg/15 mm or more were evaluated as having a low peeling risk; those with a tensile strength of 1.2 kg/15 mm to 2.5 kg/15 mm were evaluated as having a medium peeling risk; and those with a tensile strength of 1.2 kg/15 mm or less were evaluated as having a high peeling risk. The unit of strength is kg/15 mm.

(2) Oxygen Permeability Measurement

The test piece 1 and the test piece 2 were measured by using an oxygen permeability measurement apparatus OX-TRAN1/50 manufactured by MOCON, according to JIS-K7126 (equal pressure method) under conditions of 23° C. and 90% RH. RH represents relative humidity.

(3) Water Vapor Permeability Measurement

The test piece 1 and the test piece 2 were measured by using a water vapor permeability measurement apparatus PARMATRAN-W3/33MG manufactured by MOCON, according to JIS-K7129 (Infrared detection sensor method) under conditions of 40° C. and 90% RH. RH represents relative humidity.

(4) Evaluation of Heat Resistance

The test piece 1 and the test piece 2 were heated in a heating furnace at 80° C. for 5 h. Adhesion interfaces of the test pieces were visually observed and evaluated, and the anti-foaming and anti-peeling properties were evaluated by confirming presence or absence of foaming and peeling or floating.

TABLE 1

| | (Test piece 1) | | (Test piece 2) | |
|---|---|---|---|---|
| | First laminated film | | Second laminated film | |
| Thickness | 67-72 | μm | 114 | μm |
| Peeling risk | Medium | | Low | |
| Oxygen permeability | 0.6 | c.c./m² | <0.01 | c.c./m² |
| Water vapor permeability | 0.6 | c.c./m² | <0.005 | g/m² |

| | | |
|---|---|---|
| Heat resistance | High | High |

It can be seen from Example 1 that the structure with the recycled PET layer as an outer layer, the thermoplastic resin layer as an inner layer, and the barrier layer disposed between the outer layer and the inner layer can have particular mechanical strength, gas and water barrier properties, and heat resistance.

Further, when the metal foil layer is provided with the thermoplastic resin layer in direct contact on both sides thereof, as shown in Example 2, the mechanical strength, gas and water barrier properties can be further improved.

Based on the above, by using the structure of any of the embodiments of the disclosure, the package body is provided with good mechanical strength and other properties, the amount of new plastics used can be reduced, leading to resource recycling and reutilization, thereby reducing/eliminating the adverse effects caused by production of new plastics.

What is claimed is:

1. A package body, comprising a laminated film, wherein the laminated film comprises:
a recycled polyethylene terephthalate (PET) layer as an outer layer of the package body;
a first thermoplastic resin layer as an inner layer of the package body;
a barrier layer, disposed between the recycled PET layer and the first thermoplastic resin layer, and wherein the barrier layer is a metal foil layer or a metal-coated resin layer; and
a second thermoplastic resin layer, located between the recycled PET layer and the barrier layer, and wherein the second thermoplastic resin layer is in direct contact with the recycled PET layer.

2. The package body according to claim 1, wherein the first thermoplastic resin layer is selected from at least one of the group consisting of a polyethylene (PE) film, an acrylic copolymer resin film, and a polypropylene (PP) film;
the metal foil layer is an aluminum foil layer or a copper foil layer;
the metal-coated resin layer is an aluminum-coated resin layer; and
the aluminum-coated resin layer is an aluminum-coated cast polypropylene film, an aluminum-coated oriented polypropylene film, or an aluminum-coated polyethylene terephthalate film.

3. The package body according to claim 1, wherein a thickness of the recycled PET layer is less than a thickness of the first thermoplastic resin layer.

4. The package body according to claim 1, further comprising: an adhesive layer, located between the recycled PET layer and the barrier layer.

5. The package body according to claim 4, further comprising: another adhesive layer, located between the barrier layer and the first thermoplastic resin layer.

6. The package body according to claim 1, further comprising: an adhesive layer, located between the barrier layer and the first thermoplastic resin layer.

7. The package body according to claim 2, wherein the barrier layer is the metal foil layer, and the laminated film further comprises:
a third thermoplastic resin layer, located between the barrier layer and the first thermoplastic resin layer, and wherein the third thermoplastic resin layer is in direct contact with the barrier layer.

8. The package body according to claim 1, wherein an ink layer is disposed on a side of the recycled PET layer close to the first thermoplastic resin layer.

9. The package body according to claim 8, wherein the ink layer is in direct contact with the recycled PET layer.

10. The package body according to claim 1, wherein the recycled PET layer contains 0.1-2.5 wt % of isophthalate copolymer.

11. The package body according to claim 1, wherein the polyethylene (PE) film is a low density polyethylene (LDPE) film, a linear low density polyethylene (LLDPE) film, a medium density polyethylene (MDPE) film, or a high density polyethylene (HDPE) film; and wherein the polypropylene (PP) film is a cast polypropylene (CPP) film or an oriented polypropylene (OPP) film.
